(19) United States
(12) Patent Application Publication
(10) Pub. No.: US 2009/0232603 A1
(43) Pub. Date: Sep. 17, 2009

(54) In Situ Remediation Methods Using Electron Donors And Dispersant Gas

(75) Inventors: Charles B. Whisman, Lancaster, PA (US); Charles E. Blanchard, Martinez, CA (US); Denise N. Good, Lititz, PA (US)

Correspondence Address: FOX ROTHSCHILD LLP, 2000 MARKET STREET, 10th Floor, PHILADELPHIA, PA, 19103, US

(73) Assignee: Groundwater & Environmental Services, Inc., Exton, PA (US)

(21) Appl. No.: 12/402,953

(22) Filed: Mar. 12, 2009

Related U.S. Application Data
(60) Provisional application No. 61/035,878, filed on Mar. 12, 2008.

(51) Int. Cl. B09C 1/08; B09C 1/00

(52) U.S. Cl. 405/128.75; 405/128.15

(57) ABSTRACT

The present invention provides methods and systems for the in situ remediation of contaminated sites. In some embodiments, the methods and systems include one or more conduits for injection or coinjection of liquid electron donor compositions and dispersant gas compositions.

### CROSS REFERENCE TO RELATED APPLICATIONS

This application claims the benefit of the filing date of U.S. provisional application No. 61/035,878, filed Mar. 12, 2008 which is incorporated herein by reference in its entirety.

### FIELD OF THE INVENTION

The present invention is directed to methods and systems for the in situ remediation of contaminated groundwater, soils and sediment bodies, and more particularly to in situ remediation via injection of electron donor and dispersant gas compositions.

### BACKGROUND OF THE INVENTION

Many sites have become contaminated as a result of on-site activities and/or accidents. Contaminants in the environment can pose a health risk to humans, animals, and/or plants; thus there is a need to remediate these sites in a timely, cost-effective and safe manner. Contaminated media at these sites may include soils, groundwater, sediments, and/or surface water. The optimal remediation method for each site is dependent on contaminant properties, concentration, and the physical parameters that define the impacted site media. Many contaminants are most efficiently remediated by the action of an electron donor, or reducing agent. Proper distribution of such remediation agents into the contaminated site media to achieve in situ remediation is a significant challenge. Improved remediation techniques are of

In situ remediation methods broadly include oxidative, reductive and bioremediation methods. Certain classes of contaminants are more efficiently remediated using reductive and/or biological methods. These contaminants include halogenated organic species, such as chlorinated solvents, polychlorinated biphenyls (PCBs) and certain pesticides, as well as certain toxic ions, such as chromium (VI) and the anions nitrate and perchlorate. In addition, electron donors (reducing agents) may be more cost-effective than the oxidants commonly employed in the oxidative methods. Electron donors are also typically safer to handle than such oxidants.

It is known in the art that particular reductive methods are suitable for groundwater and soil remediation in situ. For example, U.S. Pat. No. 6,533,499 describes a liquid remediation system in which contaminated water is pumped through a reactive medium in a reaction chamber placed in the contaminated site media, in which the reactive medium may be a zero-valent metal.

U.S. Pat. No. 6,280,625 relates to a method for the treatment and remediation of a contaminated aquifer containing volatile organic compounds in the presence of an uncontaminated aquifer. The system comprises concentric cylinders or pipes wherein air is used to sparge and move the contaminated water within one cylinder into the second cylinder thereby allowing percolation of the contaminated water through a packing material in the second cylinder as a secondary treatment. The packing may include material such as zero-valent metals for chemical conversion of pollutants.

U.S. Pat. No. 5,975,798 describes a method for in-situ remediation wherein an inert pressurized gas in combination with an atomized iron powder-water slurry is used in a multiphase injection to place reactive zero-valent iron into channels or fractures radiating from a borehole. The groundwater then flows naturally through the reactive agent deposited in such channels or fractures, thereby effecting remediation.

U.S. Pat. No. 5,266,213 relates to a method for conducting contaminated groundwater from a native aquifer into and through a body of metal, such as iron filings, either by feeding the groundwater through a trench containing a metal, by metal injection into the contaminated site media using a drill-and-jet process, or by pumping groundwater through a surface tank or pond containing the body of metal.

U.S. Pat. No. 6,719,902 describes a method for bioremediation of mixed waste aquifers based on a synergistic combination of reductive treatment using zero-valent iron and anaerobic biotransformations accomplished by adding cultures of one or more species of hydrogenotrophic bacteria. In some embodiments permeable and semipermeable treatment walls are installed across the direction of groundwater flow.

U.S. Patent Application Publication No. 2006/0263869 relates to a process for in situ bioremediation of subsurface contaminants by stimulating anaerobic degradation, comprising the steps of a) vaporizing a liquid organic electron donor to form an electron donor gas; b) mixing the electron donor gas with a carrier gas to form a treating gas having an organic electron donor component; and c) directing the treating gas to a subsurface injection site that includes at least one perchlorate contaminant; wherein the treating gas stimulates anaerobic degradation of at least a portion of the perchlorate contaminant.

U.S. Patent Application Publication No. 2006/0094106 describes a method of stimulating microbial degradation of at least one pollutant in a subsurface environment, said method comprising contacting the subsurface environment with a) a gaseous composition comprising at least one gaseous microbial metabolic inducer, b) a carrier gas, and c) optionally one or more of a gas phase nutrient, gaseous carbon source, gas phase reductant, and moisture source. The method specifically uses gaseous compositions rather than the more readily available liquid or solution reagents.

### SUMMARY OF THE INVENTION

The present invention provides methods and systems for remediating contaminated sites, encompassing groundwater, soil, and/or sediments. A reducing environment is generated in situ, by either chemical or biological means, or both. The methods include the combination of injecting at least one electron donor in a liquid, solution, suspension or emulsion form, and injecting or coinjecting a dispersant gas. The dispersant gas is selected from hydrogen, methane, ethane, propane, nitrogen, argon, helium, air and mixtures thereof. The electron donors may be either inorganic electron donors, or organic electron donors which aid microorganisms such as bacteria to degrade halogenated contaminants such as chlorinated solvents and PCBs to innocuous products. The injected electron donors may also comprise both inorganic electron donors and organic electron donors. Multiple electron donor injections may be made, of the same or different electron donor compositions, and multiple dispersant gas injections or coinjections are also in view.

Contaminants in view for reductive remediation include halogenated organic species such as chlorinated solvents and PCBs, toxic metallic ions such as chromium (VI) and toxic non-metallic anions such as nitrate and perchlorate.

The electron donors and dispersant gases may be injected in a pulsed manner, which includes both alternating the injection sites, and varying the compositions and injection flow rates so that turbulent mixing occurs and the radius of influence (ROI) is maximized.

In a further embodiment, bacteria may be added to supplement the native microbe population and improve the remediation of specific halogenated organic molecule contaminants.

In some embodiments, the treatment system comprises:

a) one or more conduits for conducting one or more different electron donors and a dispersant gas; and

b) at least one injection port associated with each conduit.

In further embodiments, the system for treating groundwater and/or soil comprises:

a) one conduit for conducting one or more different electron donors into the groundwater through a vertically installed bore hole or well simultaneously with a dispersant gas; and

b) at least one injection port associated with the conduit for injecting or coinjecting the one or more different electron donors and dispersant gases.

In still further embodiments, the system for treating groundwater and/or soil comprises:

a) one conduit for conducting one or more electron donors into the groundwater through a borehole;

b) one conduit for conducting a dispersant gas into the groundwater through a borehole;

c) at least one injection port associated with the electron donor-carrying conduit for injecting the one or more different electron donors; and

d) at least one injection port associated with the gas-carrying conduit for injecting the dispersant gas beneath the electron donors.

In other embodiments, the system for treating groundwater and/or soil comprises:

a) one conduit for conducting one or more different electron donors into the groundwater through a horizontal infiltration field or trench simultaneously with a dispersant gas; and

b) at least one injection port associated with the conduit for injecting or coinjecting the one or more different electron donors and dispersant gases.

In other further embodiments, the system for treating groundwater and/or soil comprises:

a) one conduit for conducting one or more different electron donors into the groundwater through a horizontal infiltration field or trench;

b) one conduit for conducting a dispersant gas below the conduit carrying the one or more different electron donors;

c) at least one injection port associated with the electron donor-carrying conduit for injecting the one or more different electron donors; and

d) at least one injection port associated with the gas-carrying conduit for injecting the dispersant gas beneath the one or more different electron donors.

In still other embodiments, the system for treating groundwater and/or soil comprises one or more horizontal or vertical conduits for conducting one or more different electron donors and/or dispersant gases through an installed treatment wall.

The present invention further provides methods of treating a body of water and/or soil comprising injecting one or more electron donors and dispersant gases into the body of water and/or soil using one or more of the systems described herein.

The present invention further provides methods of lowering the concentration of halogenated organic compounds dissolved or suspended in a body of water and/or soil comprising injecting one or more electron donors into the body of water and/or soil simultaneously with a dispersant gas using one or more of the systems described herein.

### BRIEF DESCRIPTION OF THE DRAWINGS

FIG. 1 shows a diagram of an example in-situ remediation single conduit injection system according to the present invention.

FIGS. 2a and 2b show diagrams of example in-situ remediation dual conduit injection systems according to the present invention.

FIG. 3a shows a diagram of an example in-situ remediation single conduit horizontal injection system according to the present invention

FIG. 3b shows a diagram of an example in-situ remediation dual conduit horizontal injection system according to the present invention.

FIG. 4 shows a diagram of an example in-situ remediation treatment wall with multiple conduit vertical injection system according to the present invention.

### DETAILED DESCRIPTION

Applicants have discovered that production of a remediating reducing environment in situ by injection of electron donors, including inorganic electron donors such as zero-valent metals, including, but not limited to Fe(0), and/or organic electron donors such as, without limitation, carboxylic acids and their salts, sugars, alcohols, biodegradable oils and oil emulsions, organic cellulose materials, and chitin, in a liquid, solution, suspension or emulsion form, is facilitated by the injection or coinjection of a dispersant gas which serves to form a turbulent region for mixing, agitating, dispersing, and generally expanding the radius of influence (ROI) of the injected or coinjected electron donors. In a further embodiment, the reducing environment created by the inorganic electron donors may be supplemented with at least one organic electron donor, thereby enhancing the activity of native microbes toward biological remediation as well. The combination of injection of at least one electron donor with a dispersant gas provides superior remediation versus previously described reductive methods.

The term “remediation” refers to cleanup of a site to levels determined to be health-protective for its intended use. Remediation is considered to be complete once the concentrations of the target contaminants are below the established Maximum Contaminant Levels (MCL). “Contaminants” are agents that, directly or indirectly, have a detrimental effect on the environment or a living creature (for example, human, animal, insect, and/or plant). Contaminants that are amenable to reductive treatment include chlorinated hydrocarbons (for example, perchloroethene (tetrachloroethene), cis- and trans-dichloroethene, vinyl chloride, 1,1,1-trichloroethane, 1,1-dichloroethane, 1,2-dichloroethane, methylene chloride, chloroform, carbon tetrachloride), polychlorinated biphenyls (PCBs, for example, arochlor 1016); toxic metallic ions, such as chromium (VI), and toxic non-metalic anions, for example, nitrate and perchlorate. Due to its high solubility, chromium (VI), which exists in solution as dichromate ion (Cr₂O₇²⁻) or chromate ion (CrO₄²⁻), is mobile and therefore has the ability to migrate with downgradient with the flow of water. Reduction of chromium (VI) to chromium (III) lowers both the solubility and mobility of the chromium ions, and also greatly lowers the toxicity. A likely choice for remediation of chromium (VI) would be the inorganic electron donor zero-valent iron due it its rapid action, and also because the reduction product, chromium (III), would tend to incorporate into the ferric hydroxide matrix which is generated by the reaction of the zero-valent iron with groundwater.

The term “electron donor” refers to any agent or agents that when in contact with groundwater and/or soil, change the environment to promote chemical and/or biological alternations of the soil, groundwater and/or contaminants by donating electrons to another compound. “Inorganic electron donors” are chemical reducing agents such as, without limitation, zero-valent metals, for example Fe(0), Zn(0), and Al(0), and inorganic reducing salts such as ferrous sulfide. “Organic electron donors” are molecules that donate electrons to the electron transport chain of microorganisms such as bacteria, allowing them to grow and to serve as catalysts for the biological reduction of contaminants to innocuous byproducts. Typical organic electron donors include, without limitation, carboxylic acids and their salts, for example acetic acid, benzoic acid, citric acid, lactic acid, and ascorbic acid; sugars, for example, sucrose, cane sugar, corn syrup and molasses; alcohols, for example methanol and ethanol; biodegradable oils and oil emulsions, for example soybean or other vegetable oil and vegetable oil emulsions; organic cellulose materials, for example carbonaceous vegetable matter, wheat chaff and wood chips; and chitin. The electron donors may be either liquids, dissolvable solids, or finely divided insoluble solids. The species can act either directly by chemical reaction, as is the case of finely divided zero-valent iron and nano-iron, or can enhance biological action as is the case with injected lactic/citric acid, nutrients, molasses, hydrogen (dissolved) or other carbon sources, such as methane, ethane, propane, and the like.

The term “zero valent” metal refers to the element in its uncharged, metallic form.

The term “dispersant gas” refers to any gas that is injected with the electron donor to aid in its distribution and/or efficacy, and to provide agitation and mixing, and to extend the radius of influence of the injected electron donors. Typical dispersant gases may include, without limitation, nitrogen, argon, helium, and/or air. Some additional dispersant gases may be reactive gases that will aid in the reductive remediation of contaminants, either chemically, biologically or both. Typical reactive dispersant gases include hydrogen, methane, ethane, propane and the like, which may be combined with other dispersant gases to form a dispersant gas composition, in order to mitigate the flammability issues associated with the aforementioned reactive gases. Typical dispersant gas compositions may include, without limitation, 5:95 hydrogen:nitrogen, 5:95 methane:nitrogen, 5:5:90 methane:hydrogen:nitrogen, 5:95 hydrogen:air, and 5:95 methane:air. Preferably the dispersant gasses are selected from air, nitrogen, hydrogen, methane, and mixtures thereof. More preferably the dispersant gas is a mixture of nitrogen and hydrogen. Most preferably the dispersant gas is nitrogen.

The bacteria in view, for example, Dehalobacter restrictus, Desulfitobacterium dehalogenans, Dehalococcoides ethenogenes, and Dehalospirillum multivorans, are native soil microbes capable of converting halogenated organic contaminants to innocuous products.

The electron donors and dispersant gases may be injected via the same reagent line and injection port, either simultaneously (coinjection) or sequentially in any order. If injected sequentially, different electron donor compositions and dispersant gas compositions may be cycled. The electron donors and dispersant gases may also be injected via separate reagent lines and injection ports. In this embodiment the dispersant gas injection port is usually located below the electron donor injection port. The term “reagent” refers to any agent being injected as part of the system process, including but not limited to inorganic electron donors, organic electron donors and dispersant gases. The term “reagent line” refers to a means for introducing reagents into a conduit. The reagent line may be tubing or piping that is in communication with the reagent source and is inserted into a conduit such that the reagents are injected through the conduit such as, for example, to an injection port in a conduit. The term “injection port” refers to the region of conduit where electron donors are injected into the bore hole and into surrounding water, soil, and/or sediments. The injection port includes a diffuser plus diffuser media, and may also include a well screen and/or sprayer for injecting reagents. The injection port may further include one or more valves such as, for example, a check valve for resisting back blow of fluid reagents. The term “conduit” refers to a hole, passage or tunnel within and running along the length of the bore hole, trench, or treatment wall. The conduit may be encased in a casing such as polyvinyl chloride (PVC), stainless steel, or other piping. The conduit may include a diffuser through which reagents injected from the conduit diffuse into the bore hole, trench, or treatment wall and into the surroundings. The term “diffusion barrier” refers to a medium that substantially blocks or slows diffusion of reagents to undesired regions, such as regions where the reagents would not have the desired remediation effect. A diffusion barrier also directs the diffusion of reagents toward regions within the water, soil or sediments needing treatment by the reagents. Exemplary diffusion barriers include grout or bentonite in a bore hole, a well packer in a conduit, or high-density polyethylene in a trench, treatment wall, or infiltration gallery.

In some embodiments, the injection of electron donors and dispersant gas compositions is cycled to various injection points in order to aggressively pulse the operation of the system while minimizing the likelihood of the development of preferential injection pathways. Thus, in some embodiments it is preferred to vary injection recipes in multiple nested conduits by alternating, for example, pulse injection points and flow rates. In some embodiments, such cycling and mixing functions are performed by a programmable logic controller (PLC) or electronic timers, which can control the operation of the reagent and dispersant gas injection system. The PLC or timers are used to ensure that injection flow rates at each point are controlled, and in some embodiments, to pulse the operation of the system to cycle the electron donors and dispersant gas compositions through the conduits, and to control flow rates. In some embodiments, the flow rates of electron donors and dispersant gases through the injection ports (such as through a diffuser) are varied in a pulsatile fashion (i.e., the reagents are injected in pulses, as opposed to a continuous flow), to achieve optimum results. Each of the pulses may be of the same or different electron donor and/or dispersant gas composition and/or flow rate. A typical pulsed scheme may include:

1) electron donor/nitrogen or other dispersant gas injection at low flow rates and high concentrations;

2) electron donor/nitrogen or other dispersant gas injection at high flow rates and moderate concentrations;

3) electron donor with and without simultaneous dispersant gas coinjection; and

4) dispersant gas injected following the injection of electron donors to provide long-term agitation and distribution.

Thus, the combinations of reactants, cycling durations, injection locations, and injection flow rates are advantageously controlled to achieve the benefits of the invention, for example: high flow rates of electron donors and dispersant gas, up to about 40 standard cubic feet per minute (scfm) are dissolved or distributed into the groundwater and saturated soils to address adsorbed-phase and dissolved or distributed phase contaminants; dispersant gas injection aids in mixing and distributing the reagent to increase the radius-of-influence of the injection point; and low flow rate dispersant gas with or without added electron donors at approximately one to two scfm may be used, typically pulsed, to provide continual agitation of the contaminated area.

The electron donor solution, suspension or emulsion is pumped to the conduit or conduits at varying flow rates, for example, about 5 to about 75, about 10 to about 60, or about 12 to about 50 mL/min, at a pressure of at least about 10, about 15, about 18, about 20, about 22, or about 25 psig. In further embodiments, the electron donor solution flows through the conduit or conduits at a flow rate of about 0.01 to about 25 gallons per minute (gpm), preferably about 0.1 to about 10 gpm for a vertical conduit, and about 2 to about 15 gpm for a horizontal conduit. The dispersant gases of the present invention are injected at varying flow rates, for example about 0.1 to about 150 scfm.

The present invention provides, inter alia, chemical and biological reduction systems and methods, which are useful for the remediation of water, soils and sediment bodies. In accordance with some embodiments of the invention, the treatment system includes one or more injection sites (or injection points) for injection of reagents that effect remediation. Each of the injection sites may be a bore hole, trench, or treatment wall that contains one or more conduits through which reagents are injected into the surrounding water, soils or sediments. When a bore hole, trench, or treatment wall contains two or more conduits, the site can be referred to as a “nested injection site.” In some embodiments, nested injection may be conducted in existing polyvinylchloride (PVC), other plastic, or stainless steel wells via well-packing materials. The term “bore hole” refers to a hole, passage or tunnel made typically into soils, rock or other material, through which one or more conduits (i.e., wells) is placed. The bore hole may be optionally filled with various media around the conduit(s), including, for example, diffusing media (for example, sand), diffusion barriers (for example, bentonite or grout), and/or sealant (for example, grout or concrete). The bore hole is typically deeper than it is long or wide, having a depth (height) that corresponds to its largest dimension of length×width×height. The term “trench” refers to a hole, passage or tunnel made typically into soils, rock or other material through which one or more conduits is placed. The trench may be optionally filled with various media around the conduit(s), including, for example, diffusing media (for example, sand or other porous granular material), diffusion barriers (for example, bentonite or grout), and/or backfill (for example, native soil or pea gravel). The trench is typically longer than it is wide, having a length that corresponds to its largest dimension of length×width×height. The term “treatment wall” refers to a hole, passage or tunnel made typically into soils, rock or other material through which one or more conduits is placed. The wall may be optionally filled with various media around the conduit(s), including, for example, diffusing media (for example, sand), diffusion barriers (for example, bentonite or grout), and/or backfill (for example, native soil or pea gravel). The wall is typically longer and deeper than it is wide, having a width that corresponds to its smallest dimension of length×width×height (depth).

In one aspect of the invention, the remediation system includes a single conduit disposed along the length of the bore hole. The conduit terminates at an injection port where electron donors and dispersant gas injected therethrough exit into the surroundings. In some embodiments, the injection ports occur at different points along the length of the bore hole and/or each conduit injects a different electron donor and/or dispersant gas. The bore hole may be packed with any of numerous packing materials. In some embodiments, the bore hole is packed with diffusing media, such as sand, around the injection ports. Additionally, diffusion barriers comprised of, for example, bentonite or grout, may be placed at various points along the length of the bore hole. In further embodiments, a diffusion barrier may be placed within the bore hole above all of the injection ports to help prevent diffusion of reagents upward and/or away from the desired site of remediation.

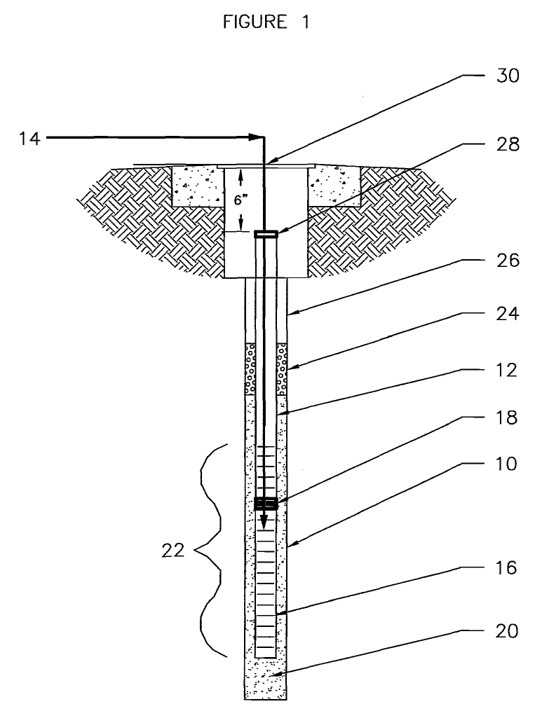

An example of a single injection site, according to the first aspect of the invention, is shown in FIG. 1. Bore hole 10 contains conductor conduit 12 which is typically a vertical pipe. A reagent conduit 14 passes through the conductor conduit and is terminated near diffuser 16 through which reagents are injected. The diffuser typically consists of a screened or screened or slotted section of the conductor casing. The slots may be replaced with any type of perforation. In some embodiments, a well packer 18 will be inserted into the conductor conduit to restrict the flow of fluids below that point. This construction will be common when existing wells are retrofitted for this purpose. The bore hole may be any convenient diameter, typically from about 2 to about 12 inches in diameter. The bore hole indicated in this case is vertical. The length of the bore hole will vary depending on the location of the contaminants to be remediated, but is typically from 1 to about 200 feet in length.

The diffuser is surrounded by the diffusing media 20. This diffusing media is typically sand or other porous granular material. The diffuser and diffuser media are collectively referred to as the injection port 22. The diffuser media is overlain by a diffusion barrier 24. The diffusion barrier may be of any material that resists diffusion of reagents. Preferred materials for diffusion barriers include suitable clays (such as bentonite) and grout. The diffusion barrier is overlain by grout seal 26 which is typically concrete or a similar material that can resist the pressure of the injected reagents. A well seal 28 is installed at the top of the conductor conduit. This well seal allows pressurization of the conductor conduit and prevents discharge of the reagents to the surface.

Reagent conduit 14 may be of any material suitable to inject the electron donor and dispersant gas. Two suitable materials are PVC or stainless steel tubing, for example ½-inch diameter stainless steel tubing. The end of conductor conduit 12 is terminated within access vault 30, which extends from the ground surface down to a point approximately 1 to 10 feet deep.

In the embodiment of FIG. 1, reagent conduit 14 injects fluid electron donor compositions (such as, for example, citric acid, lactic acid, zero-valent iron, or nano-iron solutions, suspensions or emulsions) and a dispersant gas composition such as nitrogen, hydrogen, air, or mixtures thereof.

In some embodiments, the liquid electron donor injected through reagent conduit 14 is provided via a holding tank (not shown) and injection pump (not shown). In some embodiments, the holding tank is double-walled. The electron donor in the holding tank is pumped to the conduit or conduits at varying, for example, about 5 to about 75, about 10 to about 60, or about 12 to about 50 mL/min, at a pressure of at least about 10, about 15, about 18, about 20, about 22, or about 25 psig. In further embodiments, the electron donor solution flows through the conduit at a flow rate of about 0.01 to about 25 gpm, preferably about 0.1 to about 10 gpm.

Further in connection with the embodiment of FIG. 1, a dispersant gas is injected through reagent conduit 14 either simultaneously with the electron donor, or following the electron donor injection, or in a pulsed manner.

In a second aspect of the invention, the remediation system includes at least one nested injection site in which two conduits are disposed along the length of the bore hole. One conduit terminates at an injection port where electron donors injected therethrough exit into the surroundings. A second conduit terminates at an injection port below the first conduit where dispersant gases injected therethrough exit into the surroundings. In some embodiments, the injection ports occur at different points along the length of the bore hole and/or each conduit injects a different reagent. The bore hole may be packed with any of numerous packing materials. In some embodiments, the bore hole is packed with diffusing media, such as sand, around the injection ports. Additionally, diffusion barriers comprised of, for example, bentonite or grout, may be placed at various points along the length of the bore hole. In some embodiments, a diffusion barrier is placed between injection ports when the injection ports occur at different points along the bore hole. This arrangement facilitates the movement of reagents out of the injection site into the surrounding water, soils or sediments. In further embodiments, a diffusion barrier may be placed within the bore hole above all of the injection ports to help prevent diffusion of reagents upward and/or away from the desired site of remediation.

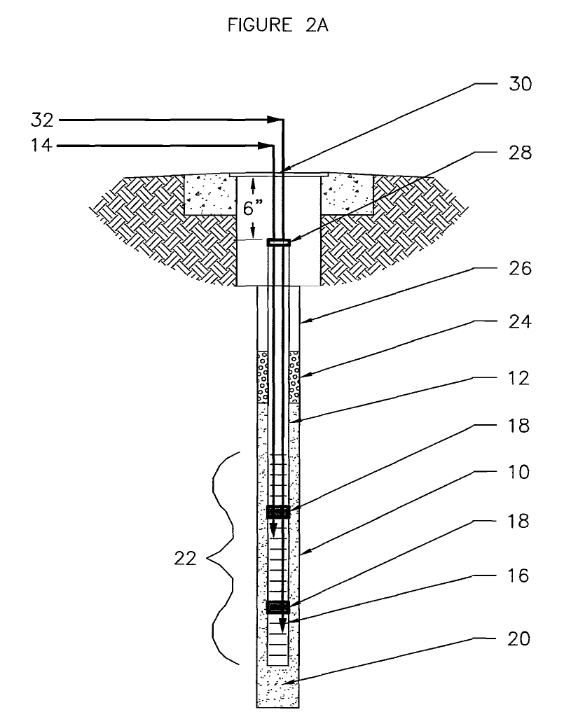

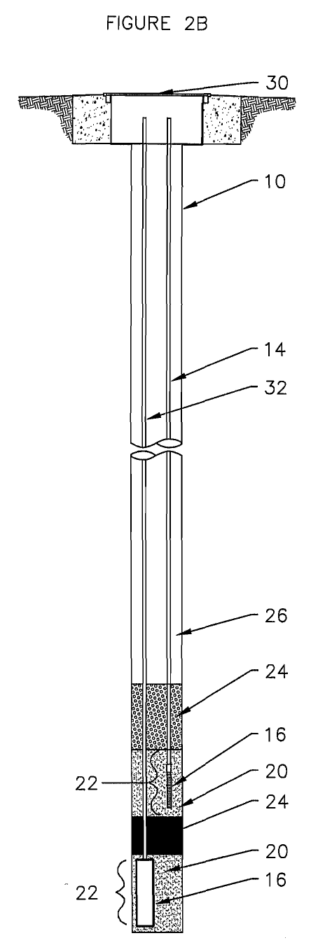

An example nested injection site, according to the second aspect of the invention, is shown in FIG. 2a. Borehole 10 contains conductor conduit 12 which is typically a vertical pipe. A reagent conduit 14 and a dispersant gas conduit 32 pass through the conductor conduit. The nitrogen conduit is terminated close to the bottom of the conductor conduit, while the reagent conduit is terminated at a point higher than the termination of the nitrogen conduit. The termination of the nitrogen conduit and the reagent conduit are separated by a well packer 18 which prevents direct mixing of these two fluids within the conductor conduit. Each conduit is terminated near a diffuser 16 through which reagents are injected. The diffuser typically consists of a screened or slotted section of the conductor casing. The slots may be replaced with any type of perforation. The bore hole may be any convenient diameter, typically from about 2 to about 12 inches in diameter. The bore hole indicated in this case is vertical. The length of the bore hole will vary depending on the location of the contaminants to be remediated, but is typically from 1 to about 200 feet in length.

The diffusers are surrounded by the diffusing media 20. This diffusing media is typically sand or other porous granular material. The diffuser and diffuser media are collectively referred to as the injection port 22. The diffuser media is overlain by a diffusion barrier 24. The diffusion barrier may be of any material that resists diffusion of reagents. Preferred materials for diffusion barriers include suitable clays (such as bentonite) and grout. The diffusion barrier is overlain by grout seal 26 which is typically concrete or a similar material that can resist the pressure of the injected reagents. A well seal 28 is installed at the top of the conductor conduit. This well seal allows pressurization of the conductor conduit and prevents discharge of the reagents to the surface.

Conduits 14 and 32 may be of any material suitable to inject the electron donor and dispersant gas (nitrogen). Two suitable materials are PVC piping or stainless steel tubing, for example ½-inch diameter stainless steel tubing. The end of conductor conduit 12 is terminated within access vault 30, which extends from the ground surface down to a point approximately 1 to 10 feet deep.

In some embodiments, the liquid electron donor composition injected through reagent conduit 14 is provided via a holding tank (not shown) and injection pump (not shown). In some embodiments, the holding tank is double-walled. The electron donor in the holding tank is pumped to the conduit or conduits at varying flow rates, for example, about 5 to about 75, about 10 to about 60, or about 12 to about 50 mL/min, at a pressure of at least about 10, about 15, about 18, about 20, about 22, or about 25 psig. In further embodiments, the reducing reagent solution flows through the conduit at a flow rate of about 0.01 to about 25 gpm, preferably about 0.1 to about 10 gpm.

The single conduit systems of the first and second aspect of the invention can be prepared by retrofitting an existing well, such as a well originally used to monitor ground water and/or subsoil composition. For example, reagent lines for delivering electron donors and/or dispersant gases can be inserted into an existing conduit or conduits, and the reagent lines can be terminated at an existing diffuser. To facilitate the diffusion of injected reagent into the surrounding water, soils and/or sediments, a well packer can be placed within the existing conduit or conduits at the points described above.

A second example nested injection site, according to the second aspect of the invention, is shown in FIG. 2b. This embodiment differs from the example in FIG. 2a in that it does not represent a retrofit of an existing well. Bore hole 10 lacks the conductor conduit which was depicted in FIG. 2a. A reagent conduit 14 and dispersant gas conduit 32 are installed directly in the borehole. The nitrogen conduit is terminated close to the bottom of the borehole, while the reagent conduit is terminated at a point higher than the termination of the nitrogen conduit. The termination of the nitrogen conduit and the reagent conduit are separated by diffusion barrier 24 which prevents direct mixing of these two fluids within the borehole. Each conduit is terminated with a diffuser 16 through which reagents are injected. The diffuser typically consists of a screened or slotted section of the reagent and nitrogen conduits. The slots may be replaced with any type of perforation. The bore hole may be any convenient diameter, typically from about 2 to about 12 inches in diameter. The bore hole indicated in this case is vertical. The length of the bore hole will vary depending on the location of the contaminants to be remediated, but is typically from 1 to about 200 feet in length.

The diffusers are surrounded by the diffusing media 20. This diffusing media is typically sand or other porous granular material. The diffuser and diffuser media are collectively referred to as the injection port 22. The upper diffuser media layer is overlain by a diffusion barrier 24. The diffusion barrier may be of any material that resists diffusion of reagents. Preferred materials for diffusion barriers include suitable clays (such as bentonite) and grout. The diffusion barrier is overlain by grout seal 26 which is typically concrete or a similar material that can resist the pressure of the injected reagents. A well seal is not required in this embodiment due to the lack of a conductor conduit.

Conduits 14 and 32 may be of any material suitable to inject the electron donor and dispersant gas (nitrogen). Two suitable materials are stainless steel tubing, for example ½-inch diameter stainless steel tubing or PVC piping. The end of conductor conduit 12 is terminated within access vault 30, which extends from the ground surface down to a point approximately 1 to 10 feet deep.

In some embodiments, the liquid electron donor injected through reagent conduit 14 is provided via a holding tank (not shown) and injection pump (not shown). In some embodiments, the holding tank is double-walled. The electron donor in the holding tank is pumped to the conduit or conduits at varying flow rates, for example, about 5 to about 75, about 10 to about 60, or about 12 to about 50 mL/min, at a pressure of at least about 10, about 15, about 18, about 20, about 22, or about 25 psig. In further embodiments, the electron donor solution flows through the conduit at a flow rate of about 0.01 to about 25 gpm, preferably about 0.1 to about 10 gpm.

In a third aspect of the invention, an injection site may contain a single horizontal conduit, through which one or more different electron donors and a dispersant gas are injected into the surrounding water, soils or sediments. The horizontal conduit may be installed in either a trench or an infiltration gallery located either above or below the water table. An infiltration gallery is similar to a trench, but consists effectively of multiple trenches side by side. They can be excavated as a group, or separately. The one or more electron donors and dispersant gas are conducted through a common reagent line into and along the length of the conduit. Multiple injection points will be installed along the conduit either as discrete ports or continuous slotting. The conduits may be made of tubing or piping comprised of any material substantially inert to the injected reagents. In some embodiments, a non-porous material may be placed above or below the injection points to channel the injected reagent flow in a desired direction. In addition, the trench or gallery through which the conduit extends may contain diffusing media around the injection port as well as a diffusion barrier (for example, grout and/or bentonite) above or below the injection port. The trench or gallery may be any convenient width, typically from about 12 to about 48 inches wide. The length of the trench will vary depending on the location and areal extent of the contaminants to be remediated.

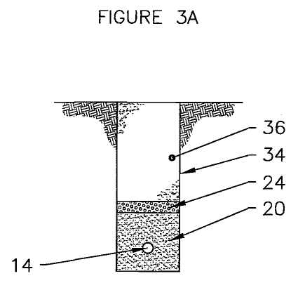

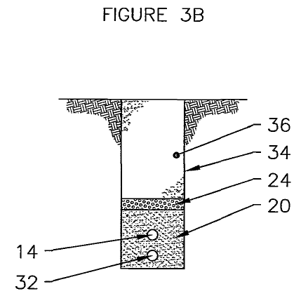

An example horizontal single injection site, according to the third aspect of the invention, is shown in FIG. 3a. A reagent conduit 14 is installed at the base of a horizontal trench or gallery. The reagent conduit itself is supplied with slots or other perforations to serve as the diffuser through which reagents are injected. The length of the trench will vary depending on the location of the contaminants to be remediated, but is typically from 5 to about 300 feet in length.

The diffusers are surrounded by the diffusing media 20. This diffusing media is typically sand or other porous granular material. The diffuser media is overlain by a diffusion barrier 24. The diffusion barrier may be of any material that resists diffusion of reagents. Preferred materials for diffusion barriers include suitable clays (such as bentonite) and grout. The diffusion barrier is overlain by backfill, typically soil.

Reagent conduit 14 may be of any material suitable to inject the electron donors and dispersant gases such as nitrogen and hydrogen. Suitable material may include PVC pipe or stainless steel.

In some embodiments, the liquid reagent injected through conduit 14 is provided via a holding tank (not shown) and injection pump (not shown). In some embodiments, the holding tank is double-walled. The electron donor in the holding tank is pumped to the conduit or conduits at varying flow rates which are dependent on the length of the trench. A 2 to 15 gpm flow rate would be typical.

In a fourth aspect of the invention, an injection site may contain dual horizontal conduits, where the upper conduit carries one or more different electron donors and the lower conduit supplies a dispersant gas into the surrounding water, soils or sediments. The horizontal conduits may be installed in either an infiltration gallery or a trench located either above or below the water table. Multiple injection points will be installed along the conduit either as discrete ports or continuous slotting. The conduits may be made of tubing or piping comprised of any material substantially inert to the injected reagents. In some embodiments, a non-porous material may be placed above or below the injection points to channel the injected reagent flow in a desired direction. In addition, the trench or gallery through which the conduit extends may contain diffusing media around the injection port as well as a diffusion barrier (for example, grout and/or bentonite) above or below the injection port. The trench or gallery may be any convenient width, typically from about 12 to about 48 inches wide. The length of the trench will vary depending on the location and areal extent of the contaminants to be remediated.

An example horizontal single injection site, according to the fourth aspect of the invention, is shown in FIG. 3b. A dispersant gas conduit 32 is installed at the base of a horizontal trench or gallery. An electron donor conduit 14 is installed above the nitrogen conduit in the same trench. Each conduit is supplied with slots or other perforations to serve as the diffuser through which reagents are injected. The trench may be any convenient width, typically from about 12 to about 48 inches in width. The length of the trench will vary depending on the location of the contaminants to be remediated, but is typically from 5 to about 300 feet in length.

The diffusers are surrounded by the diffusing media 20. This diffusing media is typically sand or other porous granular material. The diffuser media is overlain by a diffusion barrier 24. The diffusion barrier may be of any material that resists diffusion of reagents. Preferred materials for diffusion barriers include suitable clays (such as bentonite) and grout. The diffusion barrier is overlain by backfill, typically soil.

Conduits 14 and 32 may be of any material suitable to inject the electron donors and dispersant gases. Suitable materials may include PVC pipe or stainless steel.

In some embodiments, the liquid electron donor injected through conduit 14 is provided via a holding tank (not shown) and injection pump (not shown). In some embodiments, the holding tank is double-walled. The electron donor in the holding tank is pumped to the conduit or conduits at varying flow rates which are dependent on the length of the trench. A 2 to 15 gpm flow rate would be typical.

In a fifth aspect of the invention, an injection site may be one or more horizontal or vertical injection conduits installed in a fashion to create one or more treatment walls. The conduits may be installed either above and/or below the water table. The electron donors and dispersant gas may be distributed by one or more conduits (together or separate) as described in previous aspects of the invention. One or more electron donors may be injected into the injection wall with one or more dispersant gas compositions. In some embodiments, multiple injection walls may be used to distribute different electron donors and different amounts of electron donors.

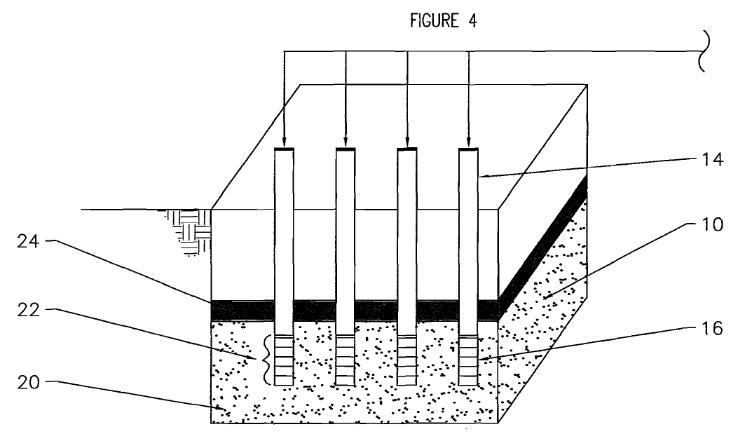

An example injection wall site, according to the fifth aspect of the invention, is shown in FIG. 4. Treatment wall 10 contains multiple reagent conduits 14 which are illustrated in this example in a vertical manner, but may be horizontal in some embodiments. Reagent conduit 14 is terminated near diffuser 16 through which electron donors and/or dispersant gases are injected. The diffuser typically consists of a screened or slotted section of the reagent conduit. The slots may be replaced with any type of perforation. The dimensions of the treatment wall will vary based on the location of contaminants to be remediated but is typically from about 5 to about 300 feet in length and from 5 to about 100 feet in width.

The diffusers are surrounded by a continuous zone of the diffusing media 20. This diffusing media is typically sand or other porous granular material. The diffusers and diffuser media are collectively referred to as injection port 22. The diffuser media may be overlain by a diffusion barrier 24. The diffusion barrier may be of any material that resists diffusion of reagents. Preferred materials for diffusion barriers include suitable clays (such as bentonite), grout, or polyethylene. The diffusion barrier may be overlain by backfill, typically soil.

Reagent conduit 14 may be of any material suitable to inject the electron donor and dispersant gas. Two suitable materials are PVC or stainless steel tubing.

In the embodiment of FIG. 4, reagent conduit 14 injects liquid electron donors (such as, for example, citric acid, lactic acid, zero-valent iron, or nano-iron solutions, suspensions, or emulsions) and a dispersant gas such as nitrogen, hydrogen, air, or mixtures thereof.

In some embodiments, the liquid electron donor composition injected through reagent conduit 14 is provided via a holding tank (not shown) and injection pump (not shown). In some embodiments, the holding tank is double-walled. The electron donor composition in the holding tank is pumped to the conduits at varying flow rates, for example, about 5 to about 75, about 10 to about 60, or about 12 to about 50 mL/min, at a pressure of at least about 10, about 15, about 18, about 20, about 22, or about 25 psig. In further embodiments, the electron donor solution flows through the conduit at a flow rate of about 0.01 to about 25 gpm, preferably about 0.1 to about 10 gpm.

Further in connection with the embodiment of FIG. 4, a dispersant gas is injected through reagent conduit 14 either simultaneously with the electron donor, or following the electron donor injection, or in a pulsed manner, or in a separate conduit.

In a sixth aspect of the invention, an injection site may contain horizontal conduits, where the upper conduit carries one or more different electron donors and the lower conduit supplies a dispersant gas into the surrounding water, soils or sediments, in addition to one or more vertical conduits. The horizontal conduits may be installed in either an infiltration gallery or a trench located either above or below the water table. Multiple injection points will be installed along the conduit either as discrete ports or continuous slotting. The conduits may be made of tubing or piping comprised of any material substantially inert to the injected reagents. In some embodiments, a non-porous material may be placed above or below the injection points to channel the injected reagent flow in a desired direction. In addition, the trench or gallery through which the conduit extends may contain diffusing media around the injection port as well as a diffusion barrier (for example, grout and/or bentonite) above or below the injection port. The trench or gallery may be any convenient width, typically from about 12 to about 48 inches wide. The length of the trench will vary depending on the location and areal extent of the contaminants to be remediated.

The vertical conduit may be along the length of the bore hole. The conduit terminates at an injection port where electron donors and dispersant gases injected therethrough exit into the surroundings. In some embodiments, the injection ports occur at different points along the length of the bore hole and/or each conduit injects a different reagent. The bore hole may be packed with any of numerous packing materials. In some embodiments, the bore hole is packed with diffusing media, such as sand, around the injection ports. Additionally, diffusion barriers comprised of, for example, bentonite or grout, may be placed at various points along the length of the bore hole. In further embodiments, a diffusion barrier may be placed within the bore hole above all of the injection ports to help prevent diffusion of reagents upward and/or away from the desired site of remediation.

The following embodiments are associated with all aspects of the invention described herein.

In some embodiments, the systems and methods of the present invention have a plurality of bore holes, each containing one or more conduits, for the introduction of reagents, and each of which may be operated individually. Typically, a system of the invention may have 5, 10, 15, 20 or more such injection locations.

In some embodiments, the systems of the invention utilize atmospheric air to obtain nitrogen gas by a pressure swing adsorption unit. In some embodiments, the nitrogen will be purchased in cylinders as a compressed gas. In some embodiments, hydrogen may be injected directly or blended with another dispersant gas. Hydrogen may be injected as a gas from bottled cylinders, hydrogen fuel-cell devices, or other hydrogen generation devices, or as a solution from devices or processes that concentrate hydrogen in water, for example the hydrogen-enriched water discharge from a proton exchange membrane. In some embodiments, the systems of the invention utilize a holding tank and transfer pump to direct electron donor compositions into the conduits.

In some embodiments, the systems of the invention can conveniently be housed in a portable carrier, for example in a trailer or container, that can be brought directly to the remediation site for either short-term or long-term injection.

In some embodiments, the aspects of the invention may be combined and used together in any fashion suitable for site-specific conditions, for example, vertical conduits and horizontal conduits within a trench.

Any of the many known inorganic electron donors and/or organic electronic donors useful for remediation may be used with the systems and methods described herein. Reagents may be injected simultaneously (for example, both dispersant gas and electron donor are coinjected) or sequentially (for example, electron donor is injected into the surroundings followed by injection of dispersant gas, or vice versa).

In some embodiments, the systems and methods of the invention may be used in conjunction with soil vapor extraction methods known in the art, for example, in which a vacuum is applied to the site of contamination to physically enhance volatilization and desorption of the contaminants from soil and/or groundwater. Thus, soil vapors are captured above the water table, including vapors produced during the chemical/biological reduction process.

The chemical and/or biological reduction systems and methods of the invention provide for the degradation of dissolved contaminants in water, particularly groundwater, soils and sediment bodies. The systems and methods herein are useful in remediating such contaminants, including any one, or combination of, those described herein.

In order that the invention disclosed herein may be better understood, examples are provided below. These examples are for illustrative purposes only and are not to be construed as limiting the invention in any manner.

### EXAMPLES

### Example 1

### Chromium Remediation

The combined injection of an inorganic electron donor (chemical reductant), specifically a nano-iron suspension, with a dispersant gas, specifically nitrogen, in accordance with the invention, is used to remediate a contaminated site, to lower soil and groundwater concentrations of chromium (VI) associated with a former chrome plating facility. Groundwater beneath the site is impacted with the soluble and toxic metallic ion Cr(VI).

Initially any ongoing sources of chromium contamination are treated through conventional means, including removal of plating tanks and piles of metal shavings. The size of the dissolved chromium plume is determined by installing monitoring wells which are sampled for total chromium and Cr(VI).

The site is treated via the injection of an inorganic electron donor by means of injection wells. An initial pilot test is performed to determine the effective radius of influence of the injected nano-iron. One or more injection wells are installed into the water table to the maximum depth at which chromium impacts are present. The injection well has a screened interval which extends from the bottom of the well to approximately 5 feet below the water table. If Cr(VI) impact is encountered even deeper in the water table, additional injection wells screened at different vertical intervals are installed as needed. Three monitoring wells are installed at distances of 5, 8, and 15 feet from the injection well(s). These wells are also installed to the maximum depth at which chromium impacts are present in the groundwater. They are screened from the bottom to the top of the water table.

The water in all of the wells is sampled for total chromium and Cr(VI). The pH and oxidation/reduction potential are measured using field instruments in all of the wells. A thin slurry of nano-iron in water is prepared and pumped into the injection well or wells at a flowrate of up to 3 gallons per minute (gpm). Iron concentrations of about 2 grams per liter are used in this application. A flowrate of up to 15 standard cubic feet per minute (scfm) is used for the nitrogen dispersant gas injected simultaneously with the nano-iron slurry. Approximately 30 pounds of nano-iron is injected into the well(s). It is anticipated that a maximum of 8 hours will be required for the injection. The nitrogen dispersant gas injection aids in forcing the iron into the aquifer both through pressure and by increasing the circulation of the groundwater. In addition, the added turbulence in the injection well itself helps to prevent settling of the iron particles by gravity.

The key parameters that are measured during the injection portion of the test include the casing pressure of the injection well or wells, the injection flow rates, and the oxidation/reduction potential (ORP) and pH in the monitoring points. Approximately once per week for four weeks following the pilot test injection, the ORP and pH are measured in the monitoring wells.

The ORP is the ratio of dissolved oxidizing species to reducing species. A low ORP will result in the direct reduction of Cr(VI) to Cr(III). Although Cr(VI) will reduce to Cr(III) at an ORP of less than 200 millivolts (mv), an ORP of zero mv is used as the cutoff for an effective ROI. The ROI of the injected inorganic electron donor is determined by the monitoring wells farthest from the injection well(s) which have an ORP of zero mv or less. In the event that an ORP of zero or less is noted in all of the injection wells, additional monitoring wells may be installed to further quantify the ORP. One month after the completion of the injection pilot test, the water in the monitoring wells and the injection well(s) is sampled for total chromium and Cr(VI).

Once the ROI of the injection points has been determined from the pilot test, a full grid of injection points is installed to cover the dissolved-phase chromium plume. The wells are installed such that their respective ROIs overlap. Nano-iron suspension is injected into the monitoring points in the same manner as the pilot test. The remediation system may be operated either continuously using piping to injection wells or periodically using a mobile treatment system that performs periodic injections. In the event that continuous injection is selected as the remedial technique, the dispersant gas composition may further comprise reducing gases such as hydrogen in addition to nitrogen.

Monitoring wells are installed throughout the chromium plume for ORP measurement and chromium sampling. These wells are monitored on a periodic basis. In the event that additional nano-iron injections are required, additional injection events are conducted. If any plugging of the wells occurs as a result of the iron injection, they are redeveloped through surging. Citric acid may also be used to help improve flow, if required, as it is a biodegradable chelating compound which would also help lower the ORP of the site.

The plume remediation is considered to be complete when a stable ORP of less than zero has been obtained throughout the source area, and the total chromium and Cr(VI) concentrations are below the established Maximum Contaminant Levels (MCL).

### Example 2

### Perchloroethene Remediation

Reductive biological remediation via organic electron donor and nitrogen dispersant gas injections is performed at a dry cleaners site that has spilled perchloroethene (PCE) cleaning solvent into the subsurface. Initial activities include identifying and eliminating the source of the PCE leak, assessing the size of the dissolved-phase plume, determining if dense non-aqueous phase liquid (DNAPL) PCE is present in the subsurface, and evaluating if impacts to the unsaturated soils (vadose zone) overlying the aquifer are present. Following the initial activities, the impacts to the vadose zone are remediated using either soil-vapor extraction, excavation, or both. The concentration of PCE breakdown products in the groundwater, including trichloroethene (TCE), dichlorethene (DCE), vinyl chloride (VC) and ethene, is determined. EPA Method 8260 is typically used for the determination of the concentration of trichloroethene (TCE), dichlorethene (DCE), vinyl chloride (VC). Ethene concentration is typically determined by an analytical method such as RSK 175. The presence of these compounds indicates that indigenous bacteria are present which are able to degrade the PCE. In the event that VC and ethene are not present, it would indicate that either the natural degradation process had not proceeded that far, or that the existing bacteria lacked the ability to process the compounds. Non-native bacteria, for example, Dehalococcoides ethenogenes, may be used to supplement the existing native bacteria as needed.

An organic electron donor is selected for injection into the subsurface. Possible options include emulsified soybean oil and various carboxylic acid salts such as sodium citrate or sodium lactate, Primary considerations are the viscosity of the organic electron donor and the permeability of the saturated zone.

Pilot testing is required to determine the ROI of the injection wells. A hexagonal grid of injection points is installed 20 feet on center. Three monitoring wells are installed within the injection grid to monitor the progress of the pilot test. Organic electron donor solution and nitrogen dispersant gas are injected into the injection wells one well at a time. Flow rates of up to three gpm of electron donor solution and up to 15 scfm of nitrogen are used for injection into the injection wells. The addition of the nitrogen to the injection wells aids in distributing the organic electron donor into the aquifer. This helps to eliminate concentration gradients which lead to poorly remediated areas, and also increases the effective ROI of each injection point.

Approximately 50 pounds of electron donor is injected into each point. Approximately 8 hours will be required for the chemical injection. Monitoring during the injection event includes measuring the pressure at the injection well, determining liquid level changes at the monitoring wells and injection wells that are not currently in use, and observing for the presence of bubbles in the wells surrounding the injection point.

Following the injection event, ORP and pH are monitored in both the injection wells and monitoring wells once every two weeks. An ORP of −400 mv or lower is considered to be the target for reductive dechlorination to occur. In the event that this ORP is achieved in the injection wells and monitoring wells, testing for the chlorinated hydrocarbons is conducted. In the event that the ORP is higher than desired, additional organic electron donor injection events are conducted. If the ORP is substantially lower in the injection wells than in the monitoring wells, the ROI would be considered less than the distance from the injection wells to the monitoring wells, and additional injection points would need to be installed to obtain better coverage. If non-native bacteria are considered to be a necessary addition at this site, they may be added at any time to any well that has an ORP of less than −100 mv and a pH between 6.5 and 8.5. The pilot test is considered successful after the ROI is established and the analytical data indicates that dechlorination of PCE is occurring.

Following the pilot test, full scale treatment of the site is conducted. This involves the installation of additional injection wells throughout the PCE plume on a spacing that is determined during the pilot test. Electron donor solution and nitrogen dispersant gas are injected into all of the injection wells. The remediation system is operated either continuously using piping to injection wells or periodically using a mobile treatment system that performs periodic injections. In the event that continuous injection is selected as the remedial technique, the dispersant gas composition may further comprise reducing gases such as hydrogen and/or methane in addition to nitrogen. The decision as to whether to use intermittent or continuous injection depends on the total mass of PCE in the subsurface. The presence of dense non-aqueous phase liquid (DNAPL) PCE in a source area would increase the likelihood that continuous injection would be required. Soil vapor extraction to control volatile organic compound (VOC) emissions may also be implemented.

Monitoring of pH and ORP is conducted to ensure that adequate coverage is obtained and also to verify that conditions are acceptable for the addition of non-native bacteria, if required. The groundwater is sampled on a quarterly basis and analyzed for PCE and its daughter products. The progress of the remediation is tracked by plotting the concentration of these compounds versus time. The remediation is considered to be complete when the concentrations of all of these compounds are below their respective MCLs.

Those skilled in the art will recognize that the above examples are illustrative of the present invention and not necessarily limiting thereto. Many other embodiments may be envisioned which are encompassed by the present invention, and the following claims.

What is claimed is:

1. A method for remediating a contaminated site, comprising:
(a) injecting a composition comprising at least one electron donor in a liquid, solution, suspension, or emulsion form; and
(b) injecting or coinjecting a composition comprising a dispersant gas selected from the group consisting of hydrogen, methane, ethane, propane, nitrogen, argon, helium, air and mixtures thereof.

2. The method of claim 1 wherein the electron donor is an inorganic electron donor.

3. The method of claim 2 wherein the inorganic electron donor is zero-valent iron.

4. The method of claim 1 wherein the electron donor is an organic electron donor.

5. The method of claim 1 wherein the electron donors are selected from both inorganic electron donors and organic electron donors.

6. The method of claim 1 further comprising injecting or coinjecting a second electron donor composition comprising at least one electron donor in a liquid, solution, suspension or emulsion form, wherein the injections of the electron donor compositions and the dispersant gas composition proceed in any order.

7. The method of claim 1 wherein the dispersant gas is selected from the group consisting of air, nitrogen, hydrogen, methane, and mixtures thereof.

8. The method of claim 7 wherein the dispersant gas is a mixture of nitrogen and hydrogen.

9. The method of claim 7 wherein the dispersant gas is nitrogen.

10. The method of claim 1 wherein the contaminants comprise halogenated organic species, toxic ions, or mixtures thereof.

11. The method of claim 1 wherein the electron donor and dispersant gas compositions are injected in a pulsed manner.

12. The method of claim 6 wherein the electron donor and dispersant gas compositions are injected in a pulsed manner.

13. The method of claim 1 in which the dispersant gas composition is injected at flow rates of about 0.1 to about 150 standard cubic feet per minute.

14. The method of claim 1 in which the dispersant gas composition is injected at flow rates of about 15 standard cubic feet per minute or higher.

15. The method of claim 1 in which the electron donor composition is injected at flow rates of about 0.01 to about 25 gallons per minute.

16. The method of claim 1 wherein injection or coinjection is by means of a vertical well, bore hole or other vertical conduit.

17. The method of claim 1 wherein injection or coinjection is by means of a horizontal trench, infiltration gallery or other horizontal conduit.

18. The method of claim 1 wherein injection or coinjection is by means of a treatment wall.

19. The method of claim 1 wherein injection or coinjection is by means of any combination of vertical well, bore hole or other vertical conduit, horizontal trench, infiltration gallery or other horizontal conduit, and treatment wall.

20. The method of claim 1 further comprising injecting or coinjecting a composition comprising at least one bacterial species to supplement the bioremediation process.

21. A system for remediating a contaminated site, comprising:
a) one conduit for conducting electron donor compositions and dispersant gas compositions into the groundwater, soil or both, through a trench;
b) one or more injection ports associated with said conduit for dispensing said electron donor and dispersant gas compositions; and
c) a diffusion barrier placed above or below said injection ports, isolating electron donor flow to a desired direction within the trench.

22. A system for remediating a contaminated site, comprising:
a) two or more conduits for conducting electron donor compositions and dispersant gas compositions separately into the groundwater, soil or both, through a trench;
b) at least one injection port associated with each of said two or more conduits for dispensing said electron donor and dispersant gas compositions; and
c) a diffusion barrier placed above or below said injection ports, isolating electron donor flow to a desired direction within the trench.

23. A system for remediating a contaminated site, comprising:
a) two or more conduits for conducting electron donor compositions and dispersant gas compositions into the groundwater, soil or both, through a treatment wall:
b) at least one injection port associated with each of said two or more conduits for dispensing said electron donor and dispersant gas compositions; and
c) a diffusion barrier placed above said injection ports, isolating electron donor flow to a desired direction within the treatment wall.
